(19) United States
(12) Patent Application Publication
(10) Pub. No.: US 2023/0068536 A1
(43) Pub. Date: Mar. 2, 2023

(54) Cable Guiding Element

(71) Applicant: Canyon Bicycles GmbH, Koblenz (DE)

(72) Inventors: Marco Anderer, Koblenz (DE); Lars Schellenberg, Koblenz (DE); Matthias Hensolt, Koblenz (DE); Johann Fatkin, Koblenz (DE)

(21) Appl. No.: 17/896,181

(22) Filed: Aug. 26, 2022

(30) Foreign Application Priority Data
Aug. 27, 2021 (DE) 202021104629.5

(51) Int. Cl. B62J 11/13; B62J 11/16

(52) U.S. Cl. CPC B62J 11/13; B62J 11/16

(57) ABSTRACT

A cable guiding element for guiding cables such as Bowden cables, hydraulic lines and the like is arranged inside a bicycle frame, in particular inside a head tube of a bicycle frame. The cable guiding element has a particularly cylindrical sleeve element. In the assembled state, the sleeve element is arranged inside the head tube and surrounds a steer tube of a bicycle fork. For defining the position of at least one cable, at least one holding element is connected with the sleeve element.

### CROSS-REFERENCE TO RELATED APPLICATION

This application claims priority to German Patent Application No. 20 2021 104 629.5 filed Aug. 27, 2021, the disclosure of which is hereby incorporated by reference in its entirety.

### BACKGROUND OF THE DISCLOSURE

### Field of the Disclosure

The disclosure relates to a cable guiding element. It is provided for guiding cables such as Bowden cables, hydraulic lines, or, for example, also cables inside a bicycle frame, in particular inside a head tube of a bicycle frame.

### Description of Related Art

In modern bicycle frames, cables such as Bowden cables, hydraulic lines, cables and the like are often laid inside the bicycle frame. In this way, such cables are inserted, for example, from the handlebar into the head tube of the bicycle frame and are then guided, for example, from the head tube of the bicycle frame into the top tube or the down tube. Depending on the type of cable, it is then guided, for example, to the rear wheel brake, to the gear system, to an actuation element for a height-adjustable saddle or the like. For example, the cables can be inserted into the head tube via an intermediate element located above the head tube or also via the handlebar stem. With cables laid inside the bicycle frame, there is the problem that the radius of the cables must not be too small in order to avoid damages to the cables. This can prevent abrasion or other damage to the cables.

### SUMMARY OF THE DISCLOSURE

An object of the disclosure is to provide a cable guiding element with which a simple assembly of cables is possible and/or the risk of a damage to cables inside the bicycle frame is reduced.

According to the disclosure, the object is achieved by a cable guiding element having the features as described herein.

The cable guiding element according to the disclosure is provided for guiding cables such as Bowden cables, hydraulic lines, or also cables inside a bicycle frame, in particular inside a head tube of a bicycle frame. The cable guiding element according to the disclosure has a sleeve element. In the assembled state, the sleeve element is arranged inside the head tube such that it preferably completely surrounds the steer tube, thus completely surrounding the steer tube in particular in the circumferential direction. According to the disclosure, at least one holding element is connected with, in particular integrally formed with the sleeve element. The holding element is provided for defining the position of at least one cable. Preferably, the sleeve element is cylindrically, in particular circular cylindrically formed and has an inner diameter being slightly larger than the outer diameter of the steer tube.

In a particularly preferred embodiment, the cable guiding element is arranged on the steer tube in a freely rotatable manner. Here, a low friction may occur between the steer tube and an inner surface of the cable guiding element. This results in a low co-rotation of the cable guiding element during steering. In order to prevent damages to the steer tube during the relative movements occurring between the inner side of the cable guiding element and the outer side of the steer tube, an intermediate element surrounding the steer tube may be arranged. For example, a cylindrical element is fixedly connected with the steer tube as an intermediate element so that the relative movement takes place between said cylindrical element and the cable guiding element. This makes it possible to realize low friction values. A sticker made of suitable material, in particular plastic, can be arranged on the steer tube as a cylindrical intermediate element.

An advantage of the disclosure is that the cable guiding element according to the invention simplifies the assembly of cables and/or reduces the risk of damage to cables. On the one hand, this is due to the fact that the cables run in a bending radius that is too small. In addition, the cable guiding element according to the disclosure has the advantage that the cables are arranged in a defined bending radius, at least in a certain area of bending radii. In this respect, it is also avoided that, for example, very stiff cables have a bending radius that is too large, and in particular stiff cables such as hydraulic lines and the like, have a defined position. This further minimizes the occurrence of wear.

Thus, the cable guiding element according to the disclosure prevents a damage to the steer tube and preferably also a damage to the laid cables. In particular due to the defined position of the cables, there is no completely free laying of the cables inside the frame. This can result in damages to the cables. For example, aluminum frames have open cut edges or protrusions inside the frame tubes that can be sharp-edged. In particular, by providing at least one holding element, the position of cables can be clearly defined.

Preferably, in the assembled state, the cables run substantially parallel to the longitudinal axis of the steer tube. In particular, the cables have an angle of less than 30° and in particular less than 20° to the longitudinal axis of the steer tube in the assembled state.

Furthermore, it is preferred that the sleeve element is arranged inside the head tube of the bicycle frame in the assembled state. Thus, in a preferred embodiment, the at least one holding element is arranged between the steer tube and the head tube. In particular, the entire sleeve element is arranged together with the holding element inside the head tube and thus not visible from the outside.

Preferably, several holding elements are connected with the sleeve element. This makes it easy to define the position of several cables using different holding elements.

Furthermore, it is particularly preferred that the at least one holding element is arranged on an outer side of the sleeve. Thus, in a preferred embodiment, the cables run along an outer side of the sleeve element and are then held or fixed in a corresponding position by the holding element. This particularly prevents that the cables contact an outer side of the steer tube and are thus damaged. In particular, a relative movement occurring between the cables and the steer tube as a result of steering can cause the outer side of the cables to be damaged.

Furthermore, it is preferred that, when several holding element are provided, at least two holding elements are arranged opposite to each other, in particular on the outer side of the sleeve element. In the assembled state, these two holding elements are arranged in the direction of travel on the left or right side of the sleeve element. This makes it easy to guide cables coming from the left side of the handlebar along the left outer side of the sleeve element to the left holding element. This is done accordingly for cables arranged on the right side.

Furthermore, it is preferred that the holding elements are arranged approximately in the center of the head tube in the assembled state. Starting from the center, the position of the holding elements can vary by less than ±20 mm, in particular less than ±10 mm. Optionally, different holding element can be provided on different heights of the sleeve element. For example, if cables are to be arranged in the top tube, a higher holding element may be provided in the assembled state than for cables guided into a down tube of the frame. In particular, it is preferred that at least a part of the holding elements in the assembled state is arranged approximately in the center of the head tube. Furthermore, it is preferred that in particular such holding elements are arranged in the area of a lower end of the sleeve element.

It is preferred that at least one holding element is configured such that it has a lead-through opening. In particular, the opening is completely closed in the circumferential direction, so that the cable is prevented from slipping out. Here, the holding element may be generally self-contained so that the cable must be passed through, or the holding element has, for example, a foldable hinge-like element so that it can be closed. This would allow easier insertion of the cable.

It is particularly preferred that the at least one holding element is arranged on an outer side of the sleeve element. In particular, the at least one holding element is fixedly connected with the sleeve element and particularly preferred integrally formed therewith, wherein preferably several sleeve elements may be provided.

Furthermore, it is preferred that the at least one holding element is connected via connecting bars with the sleeve element, in particular with an outer side of the sleeve element. Preferably, an outer side of the connecting bars is configured to transition substantially step-free on an outer side of the sleeve. Such a smooth transition prevents damage to other components during assembly or operation.

Furthermore, the disclosure relates to a cable guiding system. The cable guiding system includes a head tube of a bicycle frame as well as steer tube of a bicycle fork arranged inside the head tube of the bicycle frame. Moreover, a cable guiding element at least partially surrounding the steer tube is provided. The cable guiding element is advantageously designed and further developed as described above.

### BRIEF DESCRIPTION OF THE DRAWINGS

In the following, the disclosure is described in more detail by means of a preferred embodiment with reference to the accompanying drawings.

In the drawings:

FIG. 1 is a schematic perspective view of a cable guiding element according to the invention, and

FIG. 2 is a schematic side view of a cable guiding element mounted in a head tube according to FIG. 1.

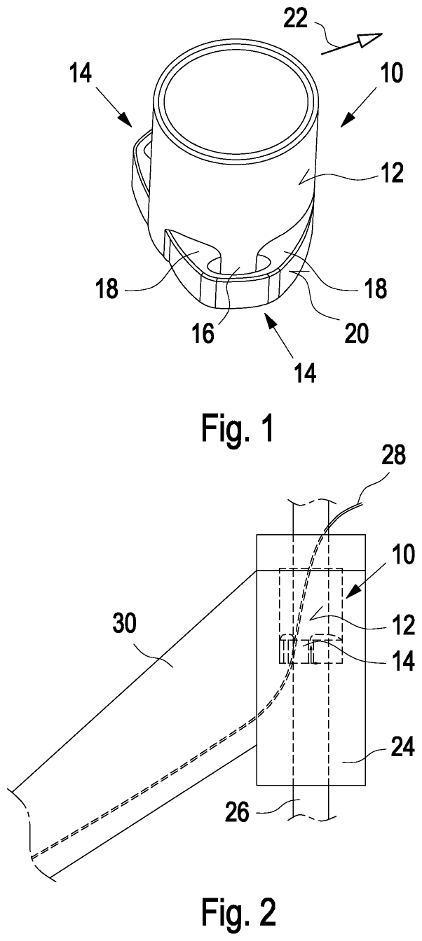

### DETAILED DESCRIPTION

The cable guiding element according to the disclosure includes a sleeve element 10 that is circular cylindrical in the exemplary embodiment shown. In the exemplary embodiment shown, two holding elements 14 are arranged on an outer side 12 of the sleeve element 10. The two holding elements 14 each have a passage opening 16 for passing through cables.

The two holding elements 14 are connected via respectively two bar-shaped elements 18 to the outer side 12 of the sleeve element 10. The bar-like elements 18 have an outer 20, which in particular transitions tangentially or at least step-free into the outer side 12 of the sleeve element.

With respect to a direction of travel 22, the two holding elements 14 are arranged opposite to each other on a left and right outer side of the sleeve element 10, respectively.

In the assembled state (FIG. 2), the cable guiding element is arranged inside the head tube 24. Furthermore, a fork tube 26 of a bicycle fork is arranged in the head tube 24 of the bicycle frame. The cable guiding element surrounds the steer tube 26. A schematically illustrated cable 28 extends, starting from a bicycle handlebar, for example inside a handlebar stem, which is not illustrated, into the head tube 24. Here, the cable 28 first rests against an outer side 12 of the sleeve element 10 and is then passed through the through opening 16 of the holding element 14. Finally, the cable 28 extends with a sufficiently large radius into a top tube 30 connected with the head tube 24.

1. A cable guiding element for guiding cables such as Bowden cables, hydraulic lines and the like inside a bicycle frame, in particular inside a head tube of a bicycle frame, comprising
a sleeve element which, in the assembled state, preferably completely surrounds the steer tube, and
at least one holding element connected with the sleeve element for defining the position of at least one cable.

2. The cable guiding element according to claim 1, wherein the cables extend, in the assembled state, substantially parallel to a longitudinal axis of the steer tube, wherein the cables preferably have an angle of less than 30°, in particular less than 20° to the longitudinal axis of the steer tube.

3. The cable guiding element according to claim 1, wherein the sleeve element is arranged together with the at least one holding element inside the head tube in the assembled state.

4. The cable guiding element according to claim 1, wherein several holding elements are connected with the sleeve element.

5. The cable guiding element according to claim 1, wherein the at least one holding element is arranged on an outer side of the sleeve element.

6. The cable guiding element according to claim 1, wherein at least two holding elements are arranged opposite to each other.

7. The cable guiding element according to claim 1, wherein the at least one holding element in the assembled state is arranged approximately in the center of the steer tube with a deviation of in particular less than ±20 mm and particularly preferred less than ±10 mm.

8. The cable guiding element according to claim 1, wherein the at least one holding element has a lead-through opening for leading through at least one cable.

9. The cable guiding element according to claim 1, wherein the at least one holding element is connected with an outer side of the sleeve element.

10. The cable guiding element according to claim 1, wherein the at least one holding element has connecting bars for connection with the sleeve element, in particular with the outer side of the sleeve element.

11. The cable guiding element according to claim 10, wherein the connecting bars have an outer side transitioning substantially step-free to the outer side of the sleeve element.

12. A cable guiding system, comprising a head tube of a bicycle frame,
a steer tube of a bicycle fork arranged inside the head tube, and
a cable guiding element surrounding the steer tube according to claim 1.
